(19) United States
(12) Patent Application Publication
(10) Pub. No.: US 2009/0210490 A1
(43) Pub. Date: Aug. 20, 2009

(54) TECHNIQUES TO AUTOMATICALLY CONFIGURE RESOURCES FOR A MULTIMEDIA CONFRENCE EVENT

(75) Inventors: Quinn Hawkins, Kirkland, WA (US); Pulin Thakkar, Redmond, WA (US); Avronil Bhattacharjee, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/033,891

(22) Filed: Feb. 20, 2008

(51) Int. Cl. G06F 15/16

(52) U.S. Cl. 709/204

(57) ABSTRACT

Techniques to automatically configure resources for a multimedia conference event are described. A system may comprise a meeting resource and a local meeting console to couple to the meeting resource. The local meeting console may include a meeting resource management module operative to manage the meeting resource for a conference room, and automatically establish a media connection between a remote meeting console and a meeting resource for a multimedia conference event. Other embodiments are described and claimed.

### BACKGROUND

A multimedia conferencing system typically allows multiple participants to communicate and share different types of media content in a collaborative and real-time meeting over a network. The multimedia conferencing system may display different types of media content using various graphic user interface (GUI) windows or views. For example, one GUI view might include video images of participants, another GUI view might include presentation slides, yet another GUI view might include text messages between participants, and so forth. The media content may be captured and displayed utilizing different types of multimedia equipment, some of which may require varying levels of configuration prior to using the multimedia equipment for a given multimedia conference event. Techniques directed to improving configuration and management of such multimedia equipment may enhance user experience and convenience.

### SUMMARY

Various embodiments may be generally directed to multimedia conference systems. Some embodiments may be particularly directed to techniques to automatically configure resources for a multimedia conference event. The multimedia conference event may include multiple participants, some of which may gather in a conference room, while others may participate in the multimedia conference event from a remote location.

In one embodiment, a system may include one or more meeting resources and a local meeting console to couple to the meeting resources. The local meeting console may include a meeting resource management module operative to manage meeting resources for a conference room. The local meeting console may establish a media connection between a remote meeting console and a meeting resource for a multimedia conference event. For example, the local meeting console may establish the media connection automatically, or in response to user commands when a participant enters the conference room and accesses the local meeting console.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an embodiment for a multimedia conference system.

FIG. 2 illustrates an embodiment of a message flow.

FIG. 3 illustrates an embodiment for a logic flow.

FIG. 4 illustrates an embodiment for a computing architecture.

### DETAILED DESCRIPTION

Various embodiments may be generally directed to multimedia conferencing systems arranged to provide meeting and collaboration services to multiple participants over a network. Some multimedia conferencing systems may be designed to operate with various packet-based networks, such as the Internet or World Wide Web (“web”), to provide web-based conferencing services. Such implementations are sometimes referred to as web conferencing systems. An example of a web conferencing system may include MICROSOFT® OFFICE LIVE MEETING made by Microsoft Corporation, Redmond, Wash. Other multimedia conferencing systems may be designed to operate for a private network or enterprise, and may utilize a multimedia conferencing server such as MICROSOFT OFFICE COMMUNICATIONS SERVER made by Microsoft Corporation, Redmond, Wash. It may be appreciated, however, that implementations are not limited to these examples.

A multimedia conferencing system may include, among other network elements, a multimedia conferencing server or other processing device arranged to provide web conferencing services. For example, a multimedia conferencing server may include, among other server elements, a server meeting module operative to control and mix different types of media content for a meeting and collaboration event, such as a web conference. A meeting and collaboration event may refer to any multimedia conference event offering various types of multimedia information in a real-time or live online environment, and is sometimes referred to herein as simply a “meeting event,” “multimedia event” or “multimedia conference event.”

In one embodiment, the multimedia conferencing system may further include one or more computing devices implemented as meeting consoles. Each meeting console may be arranged to participate in a multimedia event by connecting to the multimedia conference server. Different types of media information from the various meeting consoles may be received by the multimedia conference server during the multimedia event, which in turn distributes the media information to some or all of the other meeting consoles participating in the multimedia event As such, any given meeting console may have a display with multiple media content views of different types of media content.

The media content may be captured and displayed utilizing different types of multimedia equipment, some of which may require varying levels of configuration prior to using the multimedia equipment for a given multimedia conference event. This may be particularly true for conference room equipment, such as video cameras, video projectors, displays, whiteboards, conference phones, and so forth. Typically the configuration operations are performed manually by a user or operator when entering the conference room. Depending on the number and type of multimedia equipment present in the conference room, such configuration operations may be tedious and time consuming, thereby potentially delaying start of the multimedia conference event. Such disadvantages are exacerbated when the operator is unfamiliar with the particular type of multimedia equipment, which may vary according to a given conference room.

To solve these and other problems, a multimedia conferencing system may include a multimedia conferencing server, a local meeting console, and at least one remote meeting console. The local meeting console may be located internal to a conference room that has been previously selected for use in a multimedia conference event, while the remote meeting console may be located external to the conference room. The conference room may include multiple multimedia resources. The local meeting console may include a meeting resource management module. The meeting resource management module may be arranged to implement techniques to automatically configure one or more of the multimedia resources located in the conference room for communication with the remote meeting console prior to a start time for the multimedia conference event. The participants may then begin the multimedia event without delays typically associated with manually configuring the multimedia equipment.

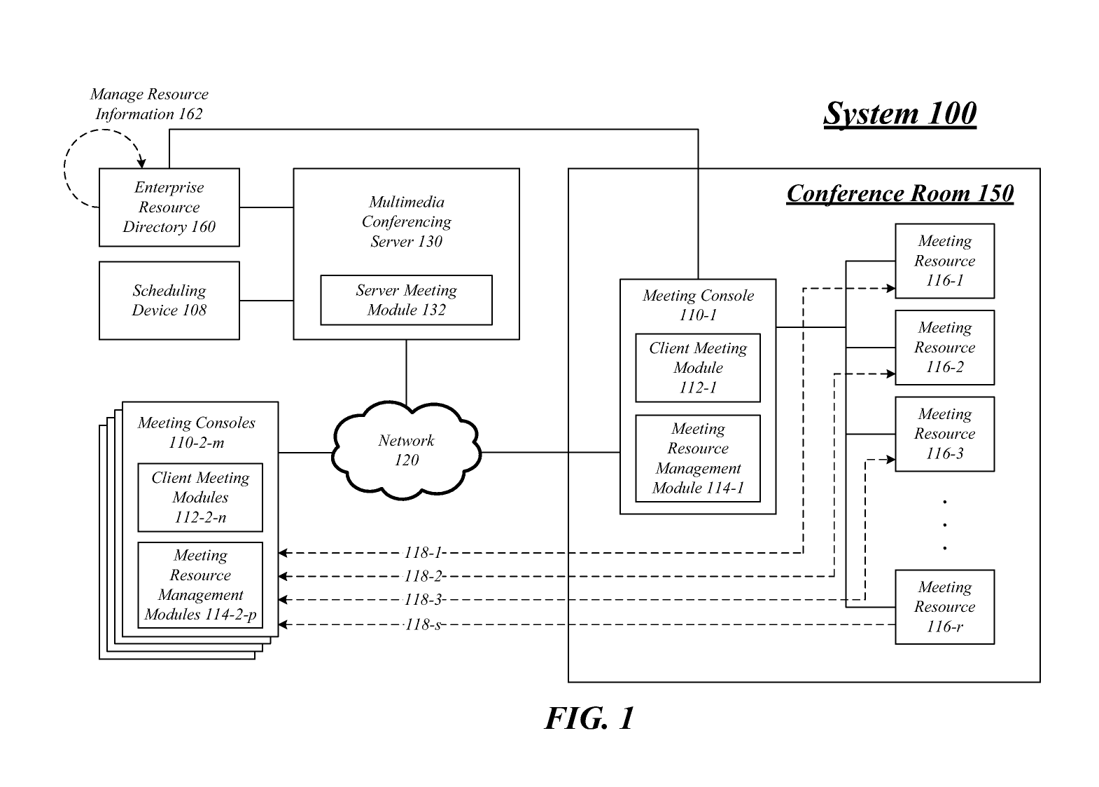

FIG. 1 illustrates a block diagram for a multimedia conferencing system 100. Multimedia conferencing system 100 may represent a general system architecture suitable for implementing various embodiments. Multimedia conferencing system 100 may comprise multiple elements. An element may comprise any physical or logical structure arranged to perform certain operations. Each element may be implemented as hardware, software, or any combination thereof, as desired for a given set of design parameters or performance constraints. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software may include any software components, programs, applications, computer programs, application programs, system programs, machine programs, operating system software, middleware, firmware, software modules, routines, subroutines, functions, methods, interfaces, software interfaces, application program interfaces (API), instruction sets, computing code, computer code, code segments, computer code segments, words, values, symbols, or any combination thereof. Although multimedia conferencing system 100 as shown in FIG. 1 has a limited number of elements in a certain topology, it may be appreciated that multimedia conferencing system 100 may include more or less elements in alternate topologies as desired for a given implementation. The embodiments are not limited in this context.

In various embodiments, the multimedia conferencing system 100 may comprise, or form part of, a wired communications system, a wireless communications system, or a combination of both. For example, the multimedia conferencing system 100 may include one or more elements arranged to communicate information over one or more types of wired communications links. Examples of a wired communications link may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The multimedia conferencing system 100 also may include one or more elements arranged to communicate information over one or more types of wireless communications links. Examples of a wireless communications link may include, without limitation, a radio channel, infrared channel, radio-frequency (RF) channel, Wireless Fidelity (WiFi) channel, a portion of the RF spectrum, and/or one or more licensed or license-free frequency bands.

In various embodiments, the multimedia conferencing system 100 may be arranged to communicate, manage or process different types of information, such as media information and control information. Examples of media information may generally include any data representing content meant for a user, such as voice information, video information, audio information, image information, textual information, numerical information, application information, alphanumeric symbols, graphics, and so forth. Media information may sometimes be referred to as “media content” as well. Control information may refer to any data representing commands, instructions or control words meant for an automated system. For example, control information may be used to route media information through a system, to establish a connection between devices, instruct a device to process the media information in a predetermined manner, and so forth.

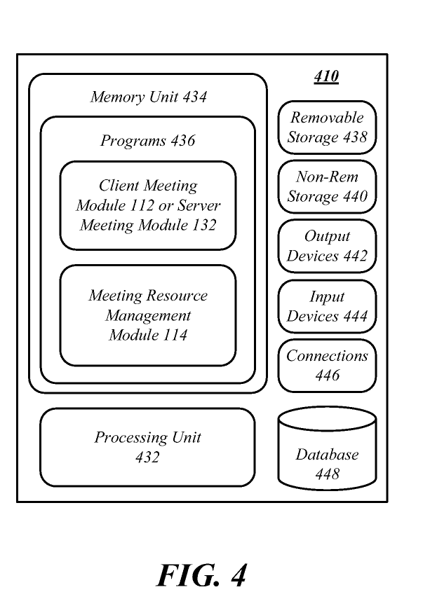

In various embodiments, multimedia conferencing system 100 may include a multimedia conferencing server 130. The multimedia conferencing server 130 may comprise any logical or physical entity that is arranged to establish, manage or control a multimedia conference call between meeting consoles 110-1-m over a network 120. Network 120 may comprise, for example, a packet-switched network, a circuit-switched network, or a combination of both. In various embodiments, the multimedia conferencing server 130 may comprise or be implemented as any processing or computing device, such as a computer, a server, a server array or server farm, a work station, a mini-computer, a mainframe computer, a supercomputer, and so forth. The multimedia conferencing server 130 may comprise or implement a general or specific computing architecture suitable for communicating and processing multimedia information. In one embodiment, for example, the multimedia conferencing server 130 may be implemented using a computing architecture as described with reference to FIG. 4. Examples for the multimedia conferencing server 130 may include without limitation a MICROSOFT OFFICE COMMUNICATIONS SERVER, a MICROSOFT OFFICE LIVE MEETING server, and so forth.

A specific implementation for the multimedia conferencing server 130 may vary depending upon a set of communication protocols or standards to be used for the multimedia conferencing server 130. In one example, the multimedia conferencing server 130 may be implemented in accordance with the Internet Engineering Task Force (IETF) Multiparty Multimedia Session Control (MMUSIC) Working Group Session Initiation Protocol (SIP) series of standards and/or variants. SIP is a proposed standard for initiating, modifying, and terminating an interactive user session that involves multimedia elements such as video, voice, instant messaging, online games, and virtual reality. In another example, the multimedia conferencing server 130 may be implemented in accordance with the International Telecommunication Union (ITU) H.323 series of standards and/or variants. The H.323 standard defines a multipoint control unit (MCU) to coordinate conference call operations. In particular, the MCU includes a multipoint controller (MC) that handles H.245 signaling, and one or more multipoint processors (MP) to mix and process the data streams. Both the SIP and H.323 standards are essentially signaling protocols for Voice over Internet Protocol (VoIP) or Voice Over Packet (VOP) multimedia conference call operations. It may be appreciated that other signaling protocols may be implemented for the multimedia conferencing server 130, however, and still fall within the scope of the embodiments.

In general operation, multimedia conferencing system 100 may be used for multimedia conferencing calls. Multimedia conferencing calls typically involve communicating voice, video, and/or data information between multiple end points. For example, a public or private packet network 120 may be used for audio conferencing calls, video conferencing calls, audio/video conferencing calls, collaborative document sharing and editing, and so forth. The packet network 120 may also be connected to a Public Switched Telephone Network (PSTN) via one or more suitable VoIP gateways arranged to convert between circuit-switched information and packet information.

To establish a multimedia conferencing call over the packet network 120, each meeting console 110-1-m may connect to multimedia conferencing server 130 via the packet network 120 using various types of wired or wireless communications links operating at varying connection speeds or bandwidths, such as a lower bandwidth PSTN telephone connection, a medium bandwidth DSL modem connection or cable modem connection, and a higher bandwidth intranet connection over a local area network (LAN), for example.

In various embodiments, the multimedia conferencing server 130 may establish, manage and control a multimedia conference call between meeting consoles 110-1-m. In some embodiments, the multimedia conference call may comprise a live web-based conference call using a web conferencing application that provides full collaboration capabilities. The multimedia conferencing server 130 operates as a central server that controls and distributes media information in the conference. It receives media information from various meeting consoles 110-1-m, performs mixing operations for the multiple types of media information, and forwards the media information to some or all of the other participants. One or more of the meeting consoles 110-1-m may join a conference by connecting to the multimedia conferencing server 130. The multimedia conferencing server 130 may implement various admission control techniques to authenticate and add meeting consoles 110-1-m in a secure and controlled manner.

In various embodiments, the multimedia conferencing system 100 may include one or more computing devices implemented as meeting consoles 110-1-m to connect to the multimedia conferencing server 130 over one or more communications connections via the network 120. For example, a computing device may implement a client application that may host multiple meeting consoles each representing a separate conference at the same time. Similarly, the client application may receive multiple audio, video and data streams. For example, video streams from all or a subset of the participants may be displayed as a mosaic on the participant's display with a top window with video for the current active speaker, and a panoramic view of the other participants in other windows.

The meeting consoles 110-1-m may comprise any logical or physical entity that is arranged to participate or engage in a multimedia conferencing call managed by the multimedia conferencing server 130. The meeting consoles 110-1-m may be implemented as any device that includes, in its most basic form, a processing system including a processor and memory, one or more multimedia input/output (I/O) components, and a wireless and/or wired network connection. Examples of multimedia I/O components may include audio I/O components (e.g., microphones, speakers), video I/O components (e.g., video camera, display), tactile (I/O) components (e.g., vibrators), user data (I/O) components (e.g., keyboard, thumb board, keypad, touch screen), and so forth. Examples of the meeting consoles 110-1-m may include a telephone, a VoIP or VOP telephone, a packet telephone designed to operate on the PSTN, an Internet telephone, a video telephone, a cellular telephone, a personal digital assistant (PDA), a combination cellular telephone and PDA, a mobile computing device, a smart phone, a one-way pager, a two-way pager, a messaging device, a computer, a personal computer (PC), a desktop computer, a laptop computer, a notebook computer, a handheld computer, a network appliance, and so forth. In some implementations, the meeting consoles 110-1-m may be implemented using a general or specific computing architecture similar to the computing architecture described with reference to FIG. 4.

The meeting consoles 110-1-m may comprise or implement respective client meeting modules 112-1-n. The client meeting modules 112-1-n may be designed to interoperate with the server meeting module 132 of the multimedia conferencing server 130 to establish, manage or control a multimedia conferencing event. For example, the client meeting modules 112-1-n may comprise or implement the appropriate application programs and user interface controls to allow the respective meeting consoles 110-1-m to participate in a web conference facilitated by the multimedia conferencing server 130. This may include input equipment (e.g., video camera, microphone, keyboard, mouse, controller, etc.) to capture media information provided by the operator of a meeting console 110-1-m, and output equipment (e.g., display, speaker, etc.) to reproduce media information by the operators of other meeting consoles 110-1-m. Examples for client meeting modules 112-1-n may include without limitation a MICROSOFT OFFICE COMMUNICATOR or the MICROSOFT OFFICE LIVE MEETING Windows Based Meeting Console, and so forth.

The meeting consoles 110-1-m may further comprise or implement respective meeting resource management modules 114-1-p. In general, the meeting resource management modules 114-1-p are operative to manage meeting resources for a conference room, and automatically establish a media connection between a remote meeting console and a meeting resource for a multimedia conference event. For example, a local meeting console 110-1 may establish the media connection automatically or programmatically. Additionally or alternatively, the local meeting console 110-1 may establish the media connection in response to operator commands when a participant enters the conference room 150 and accesses the local meeting console 110-1. In the former case, little if any manual human intervention is needed, and in the latter case, some limited manual human intervention is contemplated to facilitate convenience and control for the operator.

As shown in the illustrated embodiment of FIG. 1, the multimedia conference system 100 may include a conference room 150. An enterprise or business typically utilizes conference rooms to hold meetings. Such meetings include multimedia conference events having participants located internal to the conference room 150, and remote participants located external to the conference room 150. The conference room 150 may have various computing and communications resources available to support multimedia conference events, and provide multimedia information between one or more remote meeting consoles 110-2-m and the local meeting console 110-1. For example, the conference room 150 may include a local meeting console 110-1 located internal to the conference room 150. The local meeting console 110-1 may be connected to various meeting resources 116-1-r.

The meeting resources 116-1-r may comprise any logical or physical device capable of capturing, communicating or reproducing multimedia information. The meeting resources 116-1-r may comprise various audio and video conferencing devices or equipment that may be generally categorized into multimedia input devices and multimedia output devices.

The multimedia input devices may comprise any logical or physical device arranged to capture or receive as input multimedia information from operators within the conference room 150, including audio input devices, video input devices, image input devices, text input devices, and other multimedia input equipment. Examples of multimedia input devices may include without limitation video cameras, microphones, microphone arrays, conference telephones, whiteboards, interactive whiteboards, voice-to-text components, text-to-voice components, voice recognition systems, pointing devices, keyboards, touchscreens, tablet computers, handwriting recognition devices, and so forth. An example of a video camera may include a ringcam, such as the MICROSOFT ROUNDTABLE made by Microsoft Corporation, Redmond, Wash. The MICROSOFT ROUNDTABLE is a videoconferencing device with a 360 degree camera that provides remote meeting participants a panoramic video of everyone sitting around a conference table.

The multimedia output devices may comprise any logical or physical device arranged to reproduce or display as output multimedia information from operators of the remote meeting consoles 110-2-m, including audio output devices, video output devices, image output devices, text input devices, and other multimedia output equipment. Examples of multimedia output devices may include without limitation electronic displays, video projectors, speakers, vibrating units, printers, facsimile machines, and so forth.

The meeting resource management modules 114-1-p are operative to manage meeting resources for a conference room, and automatically establish one or more media connections 118-1-s between a remote meeting console (e.g., meeting consoles 112-2-n) and a meeting resource 116-1-r prior to a start time for a multimedia conference event. For example, the meeting resource management module 114-1 of a local meeting console 110-1 located within the conference room 150 may be arranged to automatically establish one or more media connections 118-1-s between one or more remote meeting consoles 110-2-m and one or more meeting resources 116-1-r. In various embodiments, the meeting resource management module 114-1 may be typically arranged to establish the media connections 118-1-s sometime prior to a start time for a scheduled multimedia conference event. As a result, the underlying media connections needed by the remote meeting console 110-2 will be ready for when the participants arrive in the conference room 150.

Additionally or alternatively, the meeting resource management module 114-1 may also be configured to establish the media connections 118-1-s sometime after the start time for the scheduled multimedia conference event, such as in response to a manual command from a participant within the conference room 150. This may be desirable to handle cases where the meeting coordinator or meeting participants miss the start time for the multimedia conference event. For example, the meeting resource management module 114-1 may be arranged to wait to establish the media connections 118-1-s until a meeting participant actually physically enters the conference room 150. In another example, the meeting resource management module 114-1 may be arranged to establish the media connections 118-1-s prior to the start time for the multimedia conference event, but then disconnects the media connections 118-1-s after a predetermined amount of time. When the participants finally arrive in the conference room 150, one of the participants can access the local meeting console 110-1 and re-establish the desired media connections 118-1-s with the remote meeting consoles 110-2-m. In both cases, having the meeting resource management module 114-1 wait for operator commands may conserve power and network resources.

The media connections 118-1-s may comprise any media connection suitable for transporting media information or media content. The media connections 118-1-s may be established using various VoIP signaling protocols, such as the SIP series of protocols. The SIP series of protocols are application-layer control (signaling) protocol for creating, modifying and terminating sessions with one or more participants. These sessions include Internet multimedia conferences, Internet telephone calls and multimedia distribution. Members in a session can communicate via multicast or via a mesh of unicast relations, or a combination of these. SIP is designed as part of the overall IETF multimedia data and control architecture currently incorporating protocols such as the resource reservation protocol (RSVP) (IEEE RFC 2205) for reserving network resources, the real-time transport protocol (RTP) (IEEE RFC 1889) for transporting real-time data and providing Quality-of-Service (QOS) feedback, the real-time streaming protocol (RTSP) (IEEE RFC 2326) for controlling delivery of streaming media, the session announcement protocol (SAP) for advertising multimedia sessions via multicast, the session description protocol (SDP) (IEEE RFC 2327) for describing multimedia sessions, and others. For example, the meeting resource management module 114-1 may use SIP as a signaling channel to setup the media connections 118-1-s, and RTP as a media channel to transport media information over the media connections 118-1-s.

The meeting resource management module 114-1 may establish the media connections 118-1-s using various topologies or combinations. For example, the meeting resource management module 114-1 may establish a one-to-many topology where a single remote meeting console 110-2 is connected to multiple meeting resources 116-1-r via the media connections 118-1-s. In another example, the meeting resource management module 114-1 may establish a many-to-one topology where multiple remote meeting consoles 110-2-m are connected to a single meeting resource 116-1 via multiple media connections similar to the media connection 118-1. In yet another example, the meeting resource management module 114-1 may establish a many-to-many topology where multiple remote meeting consoles 110-2-m are connected to multiple meeting resources 116-1-r via multiple media connections similar to the media connections 118-1-s.

The particular topology or combination of media connections 118-1-s may vary within a given multimedia conference event, such as when participants join or leave the multimedia conference event, or when a participant activates or deactivates a particular modality via the user interface of the client meeting modules 112-1-n. The particular topology or combination of media connections 118-1-s may vary between multimedia conference events, depending on a selected conference room and associated meeting resources available by the selected conference room.

Although the meeting resource management modules 114-1-p are shown and described with reference to the meeting modules 110-1-m by way of example and not limitation, it may be appreciated that the structure, connections and operations of the meeting resource management modules 114-1-p may be implemented for other network devices within the multimedia conference system 100, such as the multimedia conferencing server 130. This may be desirable, for example, whenever the meeting consoles 110-1-m do not have the resources to perform some or all of the configuration operations, or when the automatic configuration techniques are implemented as a network service offered by the multimedia conferencing server 130.

In general operation, a schedule device 108 may be used to generate a multimedia conference event reservation for the multimedia conferencing system 100. The scheduling device 108 may comprise, for example, a computing device having the appropriate hardware and software for scheduling multimedia conference events. For example, the scheduling device 108 may comprise a computer utilizing MICROSOFT OFFICE OUTLOOK® application software, made by Microsoft Corporation, Redmond, Wash. The MICROSOFT OFFICE OUTLOOK application software comprises messaging and collaboration client software that may be used to schedule a multimedia conference event. An operator may use MICROSOFT OFFICE OUTLOOK to convert a schedule request to a MICROSOFT OFFICE LIVE MEETING event that is sent to a list of invitees. The schedule request may include a hyperlink to a virtual room for a multimedia conference event. An invitee may click on the hyperlink, and the meeting console 110-1-m launches a web browser, connects to the multimedia conferencing server 130, and joins the virtual room. Once there, the participants can present a slide presentation, annotate documents or brainstorm on the built in whiteboard, among other tools.

An operator may use the scheduling device 108 to generate a multimedia conference event reservation for a multimedia conference event. The multimedia conference event reservation may include, in addition to a list of participants, a list of requested resources such as the conference room 150. A client application, such as a mail client for Microsoft Outlook, forwards the reservation request to the multimedia conferencing server 130. The multimedia conferencing server 130 may receive the multimedia conference event reservation, that includes the reservation of the conference room 150, and retrieve resource information 162 for the conference room 150. In one embodiment, for example, the resource information 162 for the conference room 150 may be retrieved from a network device, such as an enterprise resource directory 160.

The enterprise resource directory 160 may comprise a network device that publishes a public directory of operators and/or network resources. A common example of network resources published by the enterprise resource directory 160 includes network printers. In one embodiment, for example, the enterprise resource directory 160 may be implemented as a MICROSOFT ACTIVE DIRECTORY®. Active Directory is an implementation of lightweight directory access protocol (LDAP) directory services to provide central authentication and authorization services for network computers. Active Directory also allows administrators to assign policies, deploy software, and apply critical updates to an organization. Active Directory stores information and settings in a central database. Active Directory networks can vary from a small installation with a few hundred objects, to a large installation with millions of objects.

In various embodiments, the enterprise resource directory 160 may include resource information for various meeting resources associated with conference rooms within an organization. For example, the enterprise resource directory 160 may include resource information 162 for the meeting resources 116-1-r associated with the conference room 150. The resource information 162 may comprise any information about a meeting resource 116-1-r that may be useful in configuring, connecting, operating or otherwise managing the meeting resource 116-1-r, such as equipment type, capabilities information for each equipment type, configuration information for each equipment type, connection information for each piece of equipment, and so forth. The connection information may comprise any information useful in connecting to a meeting resource 116-1-r, including a network address, media access control (MAC) address, Internet Protocol (IP) address, telephone number, email address, protocol address (e.g., SIP address), resource identifiers, hardware configurations, software configurations, wired interfaces, wireless interfaces, supported protocols, and other desired connection information.

The multimedia conferencing server 130 may receive the multimedia conference event reservation, that includes the reservation of the conference room 150, and retrieve resource information 162 for the conference room 150 from the enterprise resource directory 160. The multimedia conferencing server 130 may then send the multimedia conference event reservation, including the reservation of the conference room 150 and associated resource information 162 for the meeting resources 116-1-r, to the local meeting console 110-1. Additionally or alternatively, the local meeting console 110-1 may be arranged to periodically retrieve updates from the multimedia conferencing server 130 for scheduled multimedia conference events.

The meeting resource management module 114-1 of the local meeting console 110-1 receives a multimedia conference event reservation from the multimedia conferencing server 130. The meeting resource management module 114-1 retrieves resource information 162 for the meeting resources 116-1-r for the conference room 150. The meeting resource management module 114-1 determines that at least one participant uses the remote meeting console 110-2, and establishes one or more media connections 118-1-s between the remote meeting console 110-2 and the meeting resources 118-1-s using the resource information 162. The meeting resource management module 114-1 accomplishes this sometime before, during or after a start time for the scheduled multimedia conference event.

The meeting resource management module 114-1 may retrieve the requisite resource information 162 from various sources. In one embodiment, for example, the meeting resource management module 114-1 may be operative to retrieve the resource information 162 directly from the multimedia conference event reservation. In this case, the multimedia conferencing server 130 may retrieve and embed the resource information 162 in the multimedia conference event reservation sent to the local meeting console 110-1. In one embodiment, for example, the meeting resource management module 114-1 may be operative to retrieve the resource information 162 directly from the enterprise resource directory 160. In this case, the multimedia conferencing server 130 may not necessarily need any modifications to existing hardware or software, since the local meeting console 110-1 has access to the enterprise resource directory 160. In one embodiment, for example, the meeting resource management module 114-1 may be operative to negotiate capability information between the remote meeting console 110-2 and the meeting resources 116-1-r to establish the media connections 118-1-s. In this case, the meeting resources 116-1-r may need to be relatively intelligent devices capable of communicating such capabilities information.

The meeting resource management module 114-1 may establish the media connections 118-1-s between the remote meeting consoles 110-2-m and the meeting resources 116-1-r as an audio connection, a video connection or a data connection, depending on the type of equipment implemented for the meeting resources 116-1-r. For example, assuming the meeting resource 116-1 comprises a Microsoft RoundTable ringcam, the meeting resource management module 114-1 may establish the media connection 118-1 as a video connection between the remote meeting console 110-2 and the meeting resource 116-1. In another example, assuming the meeting resource 116-2 comprises a conference phone, the meeting resource management module 114-1 may establish the media connection 118-2 as an audio connection between the remote meeting console 110-2 and the meeting resource 116-2. In yet another example, assuming the meeting resource 116-3 comprises an interactive whiteboard, the meeting resource management module 114-1 may establish the media connection 118-3 as a data connection between the remote meeting console 110-2 and the meeting resource 116-3. The embodiments are not necessarily limited in the number and type of media connections 118-1-s that can be established by the meeting resource management module 114-1 for a given multimedia conference event, aside from resource limitations associated with the remote meeting consoles 110-2-m, the multimedia conferencing server 130, or the meeting resources 116-1-r.

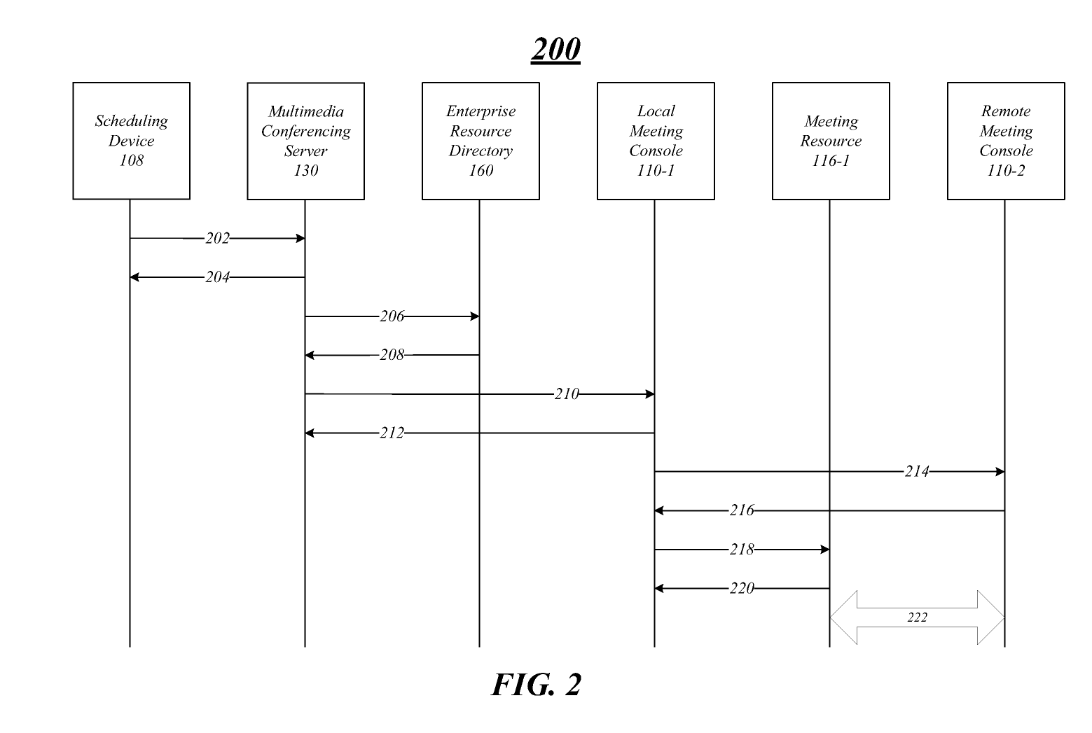

FIG. 2 illustrates an embodiment of a message flow 200. The message flow 200 may illustrate a representative message flow between various elements of the multimedia conferencing system 100 as described with reference to FIG. 1 in accordance with various embodiments. The message flow 200 may represent a message flow suitable for signaling or control messages to setup and establish media connections 118-1-s. It may be appreciated that other message flows may be used to manage and terminate the media connections during or after the multimedia conference event.

In the illustrated embodiment shown in FIG. 2, the scheduling device 108 may send a multimedia conference event reservation request with the conference room 150 as a requested resource to the multimedia conferencing server 130 as indicated by the arrow 202. The multimedia conferencing server 130 may optionally send an ACK message to the scheduling device 108 as indicated by the arrow 204.

The multimedia conferencing server 130 may receive the multimedia conference event reservation, that includes the reservation of the conference room 150, and send a message to retrieve resource information 162 for the conference room 150 from the enterprise resource directory 160 as indicated by the arrow 206. The enterprise resource directory 160 may perform a resource lookup to retrieve a list of meeting resources 116-1-r associated with the conference room 150. The enterprise resource directory 160 may then retrieve corresponding resource information 162 for each of the meeting resources 116-1-r associated with the conference room 150. The enterprise resource directory 160 may then send the list of meeting resources 116-1-r and associated resource information 162 to the multimedia conferencing server 130 as indicated by the arrow 208.

Once the multimedia conferencing server 130 receives the list of meeting resources 116-1-r and corresponding resource information 162, the multimedia conferencing server 130 may send the multimedia conference event reservation with this information to the local meeting console 110-1 located in the conference room 150 as indicated by the arrow 210. The local meeting console 110-1 may optionally send an ACK message to the multimedia conferencing server 130 as indicated by the arrow 212.

The local meeting console 110-1 may receive the multimedia conference event reservation with the conference room 150, list of associated meeting resources 116-1-r, and corresponding resource information 162 for each of the associated meeting resources 116-1-r. The meeting resource management module 114-1 may retrieve the resource information 162 for the meeting resources 116-1-r from the multimedia conference event registration message, determine at least one participant uses a remote meeting console 110-2, and establish a media connection 118-1 between the remote meeting console 110-2 and a meeting resource 116-1 using the resource information 162 prior to a start time for the multimedia conference event.

To establish the media connection 118-1, the meeting resource management module 114-1 of the local meeting console 110-1 may perform operations similar to a call transfer. The meeting resource management module 114-1 may communicate with each of the respective remote meeting console 110-2 and the meeting resource 116-1 to negotiate capabilities information, establish separate connections with each device, and then join the connections. For example, the meeting resource management module 114-1 of the local meeting console 110-1 may exchange messages with the remote meeting console 110-2 to establish a first intermediate connection as indicated by arrows 214, 216. The meeting resource management module 114-1 of the local meeting console 110-1 may further exchange messages with the meeting resource 116-1 to establish a second intermediate connection as indicated by arrows 218, 220. The meeting resource management module 114-1 of the local meeting console 110-1 may then connect the first and second intermediate connections to form the media connection 118-1 between the remote meeting console 110-2 and the meeting resource 116-1 as indicated by the arrow 222. In this manner, the meeting resource management module 114-1 takes a more active role in establishing the media connection 118-1.

Additionally or alternatively, the meeting resource management module 114-1 of the local meeting console 110-1 may take a more passive role in establishing the media connection 118-1 by sending the appropriate resource information 162 to the remote meeting console 110-2, or information about the remote meeting console 110-2 to the meeting resource 116-1-r. The remote meeting console 110-2 may then negotiate capabilities information directly with the meeting resource 116-1, and establish the media connection 118-1 with the meeting resource 116-1.

In some cases, the multimedia conferencing server 130 may comprise a legacy device that is not capable of retrieving resource information 162 for meeting resources 116-1-r from the enterprise resource directory 160. In such cases, instead of retrieving the resource information 162 from the multimedia conference event reservation, the meeting resource management module 114-1 may retrieve the resource information 162 directly from the enterprise resource directory 160, and establish the requisite media connections 118-1-s accordingly.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

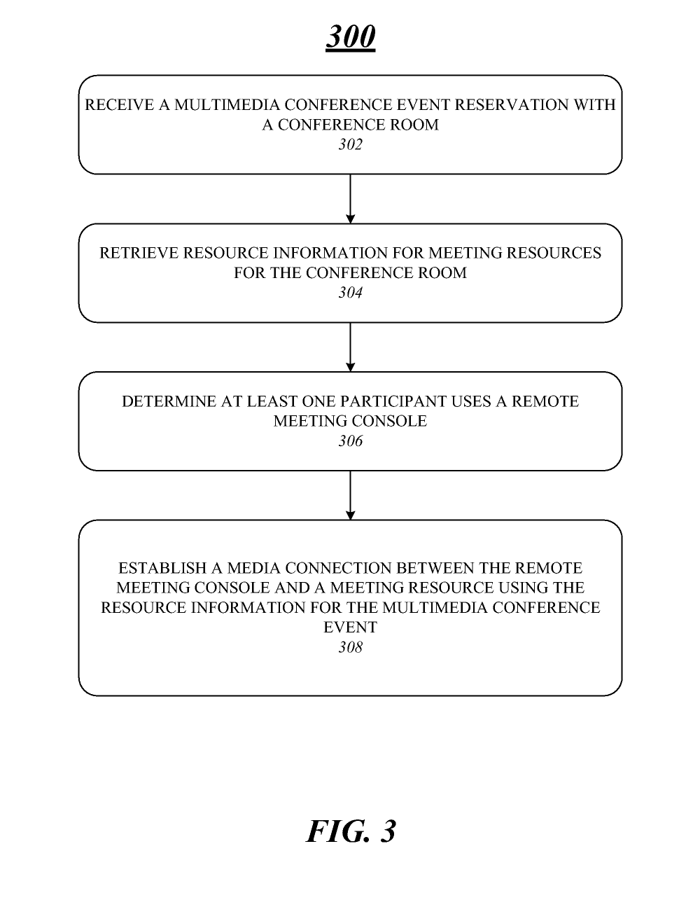

FIG. 3 illustrates one embodiment of a logic flow 300. Logic flow 300 may be representative of some or all of the operations executed by one or more embodiments described herein.

The logic flow 300 may receive a multimedia conference event reservation with a conference room at block 302. For example, the meeting resource management module 114-1 may receive a multimedia conference event reservation with the conference room 150 from the multimedia conferencing server 130.

The logic flow 300 may retrieve resource information for meeting resources for the conference room at block 304. For example, the meeting resource management module 114-1 may retrieve resource information 162 for meeting resources 116-1-r for the conference room 150 from the multimedia conference event reservation or the enterprise resource directory 160.

The logic flow 300 may determine at least one participant uses a remote meeting console at block 306. For example, the meeting resource management module 114-1 may determine at least one participant uses a remote meeting console 110-2. This may be accomplished, for example, by retrieving location information from the multimedia conference event reservation or the enterprise resource directory 160.

The logic flow 300 may establish a media connection between the remote meeting console and a meeting resource using the resource information for the multimedia conference event at block 308. For example, the meeting resource management module 114-1 may establish one or more media connections 118-1-s between the remote meeting console 110-2 and one or more meeting resources 116-1-r using the resource information 162 sometime before, during or after the start time for the multimedia conference event.

FIG. 4 further illustrates a more detailed block diagram of computing architecture 410 suitable for implementing the meeting consoles 110-1-m, the multimedia conferencing server 130, or the meeting resources 116-1-r. In a basic configuration, computing architecture 410 typically includes at least one processing unit 432 and memory 434. Memory 434 may be implemented using any machine-readable or computer-readable media capable of storing data, including both volatile and non-volatile memory. For example, memory 434 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. As shown in FIG. 4, memory 434 may store various software programs, such as one or more application programs 436-1-t and accompanying data. Depending on the implementation, examples of application programs 436-1-t may include server meeting module 132, client meeting modules 112-1-n, or meeting resource management modules 114-1-p.

Computing architecture 410 may also have additional features and/or functionality beyond its basic configuration. For example, computing architecture 410 may include removable storage 438 and non-removable storage 440, which may also comprise various types of machine-readable or computer-readable media as previously described. Computing architecture 410 may also have one or more input devices 444 such as a keyboard, mouse, pen, voice input device, touch input device, measurement devices, sensors, and so forth. Computing architecture 410 may also include one or more output devices 442, such as displays, speakers, printers, and so forth.

Computing architecture 410 may further include one or more communications connections 446 that allow computing architecture 410 to communicate with other devices. Communications connections 446 may include various types of standard communication elements, such as one or more communications interfaces, network interfaces, network interface cards (NIC), radios, wireless transmitters/receivers (transceivers), wired and/or wireless communication media, physical connectors, and so forth. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. The terms machine-readable media and computer-readable media as used herein are meant to include both storage media and communications media.

In some cases, various embodiments may be implemented as an article of manufacture. The article of manufacture may include a storage medium arranged to store logic and/or data for performing various operations of one or more embodiments. Examples of storage media may include, without limitation, those examples as previously described. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
receiving a multimedia conference event reservation with a conference room;
retrieving resource information for meeting resources for the conference room;
determining at least one participant uses a remote meeting console; and
establishing a media connection between the remote meeting console and a meeting resource using the resource information for the multimedia conference event.

2. The method of claim 1, comprising receiving the multimedia conference event reservation with the conference room from a multimedia conference server.

3. The method of claim 1, comprising retrieving the resource information from the multimedia conference event reservation.

4. The method of claim 1, comprising retrieving the resource information from an enterprise resource directory.

5. The method of claim 1, comprising establishing the media connection between the remote meeting console and the meeting resource by a local meeting console internal to the conference room.

6. The method of claim 1, comprising establishing the media connection between the remote meeting console and the meeting resource by a multimedia conference server external to the conference room.

7. The method of claim 1, comprising negotiating capability information between the remote meeting console and a local meeting console to establish the media connection.

8. The method of claim 1, comprising establishing the media connection between the remote meeting console and the meeting resource as an audio connection, a video connection or a data connection.

9. The method of claim 1, comprising establishing multiple media connections between the remote meeting console and multiple meeting resources prior to a start time for the multimedia conference event, the media connections comprising an audio connection, a video connection or a data connection.

10. An article comprising a computer-readable storage medium containing instructions that if executed enable a system to:
receive a multimedia conference event reservation with a conference room;
retrieve resource information for meeting resources for the conference room;
determine at least one participant uses a remote meeting console; and
establish a media connection between the remote meeting console and a meeting resource by the local meeting console using the resource information before a start time for the multimedia conference event.

11. The article of claim 10, further comprising instructions that if executed enable the system to retrieve the resource information from the multimedia conference event reservation.

12. The article of claim 10, further comprising instructions that if executed enable the system to retrieve the resource information from an enterprise resource directory.

13. The article of claim 10, further comprising instructions that if executed enable the system to establish the media connection between the remote meeting console and the meeting resource as an audio connection, a video connection or a data connection.

14. A system, comprising:
a meeting resource; and
a local meeting console to couple to the meeting resource, the local meeting console having a meeting resource management module operative to manage the meeting resource for a conference room, and automatically establish a media connection between a remote meeting console and the meeting resource for a multimedia conference event.

15. The system of claim 14, the meeting resource management module operative to receive a multimedia conference event reservation with the conference room, retrieve resource information for meeting resources for the conference room, determine at least one participant uses a remote meeting console, and establish the media connection between the remote meeting console and the meeting resource using the resource information for the multimedia conference event.

16. The system of claim 14, the meeting resource management module operative to receive the multimedia conference event reservation with the conference room from a multimedia conference server.

17. The system of claim 14, the meeting resource management module operative to retrieve the resource information from the multimedia conference event reservation.

18. The system of claim 14, the meeting resource management module operative to retrieve the resource information from an enterprise resource directory.

19. The system of claim 14, the meeting resource management module operative to negotiate capability information between the remote meeting console and a local meeting console to establish the media connection.

20. The system of claim 14, the meeting resource management module operative to establish the media connection between the remote meeting console and the meeting resource as an audio connection, a video connection or a data connection.
